(19) United States
(12) Patent Application Publication
(10) Pub. No.: US 2010/0113010 A1
(43) Pub. Date: May 6, 2010

(54) REPRIORITIZATION OF WIRELESS NETWORKS FOR RESELECTION TO SUPPORT VOICE CALL

(75) Inventors: Nathan Edward Tenny, Poway, CA (US); Parag A. Agashe, San Diego, CA (US); Kalle Ahmavaara, San Diego, CA (US); Masakazu Shirota, Yokohama-shi (JP); Osok Song, San Diego, CA (US); Fatih Ulupinar, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/610,621

(22) Filed: Nov. 2, 2009

Related U.S. Application Data
(60) Provisional application No. 61/110,859, filed on Nov. 3, 2008.

(51) Int. Cl. H04W 24/00; H04W 36/00

(52) U.S. Cl. 455/423; 455/437

(57) ABSTRACT

Techniques for originating a voice call by a UE after performing reselection with reprioritization are described. The UE may operate in an idle mode and may camp on a first wireless network of a first radio access technology (RAT), which may not support voice service. The first wireless network may have the highest priority among all wireless networks detected by the UE. The UE may receive an indication to originate a voice call. The UE may then perform reselection from the first wireless network to a second wireless network of a second RAT by modifying the priorities of the frequencies of the first wireless network and/or the second wireless network. The UE may then originate the voice call with the second wireless network, instead of the first wireless network, in order to avoid having to perform circuit-switched (CS) fallback from the first wireless network to the second wireless network.

The present application claims priority to provisional U.S. Application Ser. No. 61/110,859, entitled “A METHOD AND APPARATUS FOR REPRIORITISATION OF FREQUENCY IN WIRELESS COMMUNICATION SYSTEM,” filed Nov. 3, 2008, assigned to the assignee hereof and incorporated herein by reference.

### BACKGROUND

I. Field

The present disclosure relates generally to communication, and more specifically to techniques for supporting call origination in wireless communication networks.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A user equipment (UE) may be located within the coverage of multiple wireless networks, which may support different communication services. A suitable wireless network may be selected to serve the UE based on one or more criteria. The selected wireless network may be unable to provide a desired communication service (e.g., voice service) for the UE. A set of procedures may then be performed to redirect the UE to another wireless network that can provide the desired communication service. This set of procedures (if available) may involve exchanges of signaling messages between various network entities and may be time consuming. It may be desirable to obtain the desired communication service while reducing delay and signaling to the extent possible.

### SUMMARY

Techniques for originating a voice call by a UE after performing reselection with reprioritization are described herein. The UE may operate in an idle mode and may camp on a first wireless network of a first radio access technology (RAT), which may not support voice service. The first wireless network may have the highest priority among all wireless networks detected by the UE and may be selected due to its priority. The UE may receive an indication to originate a voice call, e.g., from a user. The UE may then perform reselection from the first wireless network to a second wireless network of a second RAT by modifying the priority of at least one frequency of the first wireless network and/or the priority of at least one frequency of the second wireless network. The UE may be previously registered with the second wireless network and may thus be able to avoid performing registration after reselection. The UE may originate the voice call with the second wireless network, instead of the first wireless network, in order to avoid having to perform circuit-switched (CS) fallback from the first wireless network to the second wireless network.

In one design, the UE may perform reselection based on a priority list comprising a set of frequencies, a RAT for each frequency, and a priority of each frequency. The first and second wireless networks may operate on two or more frequencies in the priority list. The UE may modify at least one priority of at least one frequency in the priority list to invoke selection of the second wireless network over the first wireless network. For example, the UE may elevate the priority of each frequency used for the second RAT and/or reduce the priority of each frequency used for the first RAT in order to invoke selection of the second RAT over the first RAT. In one design, the UE may obtain a set of flags for the set of frequencies in the priority list, e.g., one flag for each frequency. The flag for each frequency may indicate whether the priority of that frequency can be modified by the UE for reselection prior to voice call origination. The UE may modify the priority of each frequency having priority that can be modified.

In one design, the UE may determine whether to perform either (i) call origination with CS fallback or (ii) call origination with reselection to avoid CS fallback, based on one or more criteria. For example, the UE may perform call origination with CS fallback and may originate the voice call with the first wireless network if CS fallback is supported by the first wireless network. The UE may perform reselection and then originate the voice call with the second wireless network if CS fallback is not supported by the first wireless network.

Various aspects and features of the disclosure are described in further detail below.

### BRIEF DESCRIPTION OF THE DRAWINGS

FIG. 1 shows an exemplary deployment of multiple wireless networks.

FIG. 2 shows a call flow for mobile-originated voice call with CS fallback.

FIG. 3 shows a call flow for mobile-originated voice call with reselection via reprioritization prior to call origination.

FIG. 4 shows a call flow for providing configuration information for reprioritization to a UE.

FIG. 5 shows a process for originating a voice call.

FIG. 6 shows an apparatus for originating a voice call.

FIG. 7 shows a process for sending configuration information.

FIG. 8 shows an apparatus for sending configuration information.

FIG. 9 shows a block diagram of a UE and other network entities.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a RAT such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. IS-2000 is also referred to as 1X Radio Transmission Technology (1xRTT), CDMA2000 1X, etc. A TDMA network may implement a RAT such as Global System for Mobile Communications (GSM). An OFDMA network may implement a RAT such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and RATs mentioned above as well as other wireless networks and RATs. For clarity, certain aspects of the techniques are described below for LTE and 1xRTT.

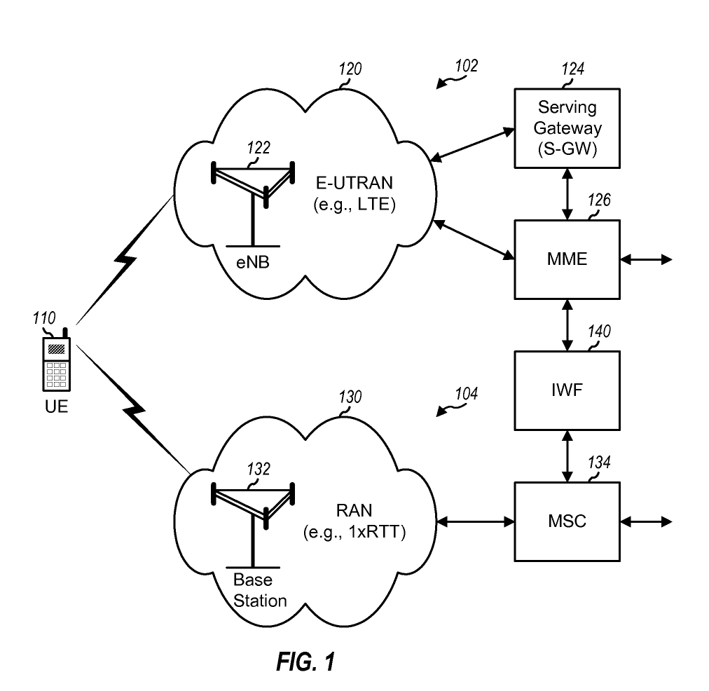

FIG. 1 shows an exemplary deployment in which multiple wireless networks have overlapping coverage. An Evolved Universal Terrestrial Radio Access Network (E-UTRAN) 120 may support LTE and may include a number of Evolved Node Bs (eNBs) 122 and other network entities that can support wireless communication for UEs. Each eNB may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network triggered services, etc. A Mobility Management Entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A Radio Access Network (RAN) 130 may support 1xRTT and may include a number of base stations 132 and other network entities that can support wireless communication for UEs. A mobile switching center (MSC) 134 may communicate with RAN 130 and may support voice services, provide routing for circuit-switched calls, and perform mobility management for UEs located within the area served by MSC 134. An Inter-Working Function (IWF) 140 may facilitate communication between MME 126 and MSC 134. The network entities in 1xRTT are described in publicly available documents from 3GPP2.

E-UTRAN 120, serving gateway 124, and MME 126 may be part of an LTE network 102. RAN 130 and MSC 134 may be part of a 1xRTT network 104. For simplicity, FIG. 1 shows only some network entities in the LTE network and the 1xRTT network. The LTE and 1 xRTT networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for 1 xRTT and may have the lowest priority, and frequency Z may also be used for 1 xRTT and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for Voice-over-Internet Protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1xRTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

Call origination with CS fallback from a source RAT to a target RAT may be performed in accordance with a set of procedures. This set of procedures may be dependent on the particular source and target RATs. Different signaling exchanges may be used for different source and target RATs.

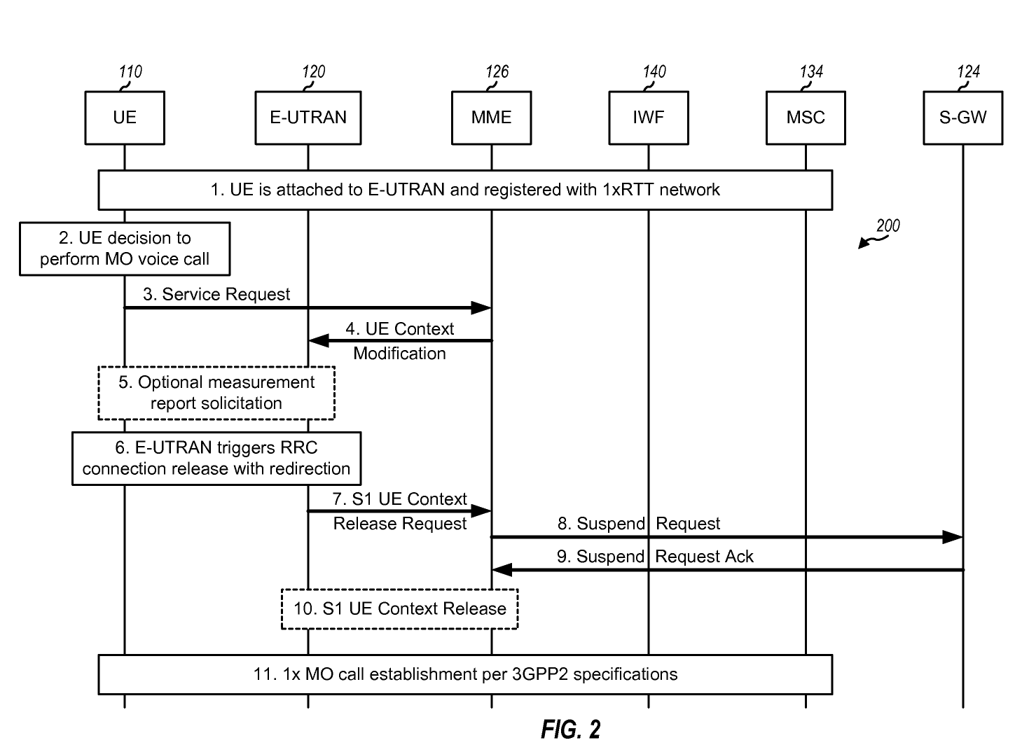

FIG. 2 shows an exemplary call flow 200 for call origination with CS fallback for a mobile-originated (MO) voice call. For clarity, FIG. 2 shows CS fallback from LTE to 1xRTT. UE 110 may be attached to E-UTRAN 120 in LTE network 102, may operate in the idle mode at the radio level, and may camp on a cell of eNB 122 in E-UTRAN 120 (step 1). UE 110 may also be registered with 1xRTT network 104 (also step 1). At some point in time, UE 110 may receive an indication to originate a voice call, e.g., from a user (step 2). UE 110 may then send a service request for a voice call via E-UTRAN 120 to MME 126 (step 3). MME 126 may receive the service request from UE 110 and may determine that LTE network 102 does not support the requested voice call. MME 126 may then send a UE context modification message via an S1 interface to eNB 122 within E-UTRAN 120 (step 4). The UE context may include parameters of IP bearer service (e.g., for quality-of-service (QoS) and security), routing information (e.g., serving gateway address), etc.

UE 110 may communicate with E-UTRAN 120 for measurement reporting (step 5). UE 110 may make measurements of detected cells and may send a measurement report to E-UTRAN 120. E-UTRAN 120 may then trigger release of a Radio Resource Control (RRC) connection for UE 110 with LTE network 102 and may redirect UE 110 to 1xRTT network 104 (step 6). E-UTRAN 120 may thereafter communicate with MME 126 and serving gateway 124 to release the UE context (steps 7 through 10). After step 6, UE 110 may perform mobile-originated call establishment with 1xRTT network 104 in accordance with 3GPP2 specifications (step 11).

As shown in FIG. 2, call origination with CS fallback may include various steps to redirect UE 110 to another wireless network that can support voice service. These steps may delay the voice call and increase signaling. Furthermore, call origination with CS fallback may not be defined for all RATs and may not be available for all wireless networks. It may thus be desirable to avoid performing call origination with CS fallback if possible.

A mobile-originated voice call with CS fallback (e.g., as shown in FIG. 2) may take place in a scenario in which UE 110 is operating in the idle mode and camping on the highest priority frequency/RAT that meets one or more criteria. UE 110 may have good radio coverage from both LTE network 102 and 1xRTT network 104 (and/or other “CS fallback” RATs). UE 110 may select LTE network 102 to camp on due to the LTE frequency having a higher priority than the priorities of the frequencies for 1xRTT (and/or other RATs). Call origination with CS fallback may then result from UE 110 (i) camping on LTE network 102 due to the higher priority of the LTE frequency and (ii) initiating the voice call with the LTE network while camped on the LTE network.

In an aspect, UE 110 may be able to avoid CS fallback by camping on a RAT that supports voice service before originating a voice call. UE 110 may be able to switch wireless network while in the idle mode via a process commonly referred to as cell reselection, or simply, reselection. UE 110 may perform reselection when an indication to originate the voice call is received, e.g., from a user. For reselection, the priorities of frequencies/RATs may be adjusted to enable reselection from the current serving RAT to a target RAT on which the voice call can be originated, as described below.

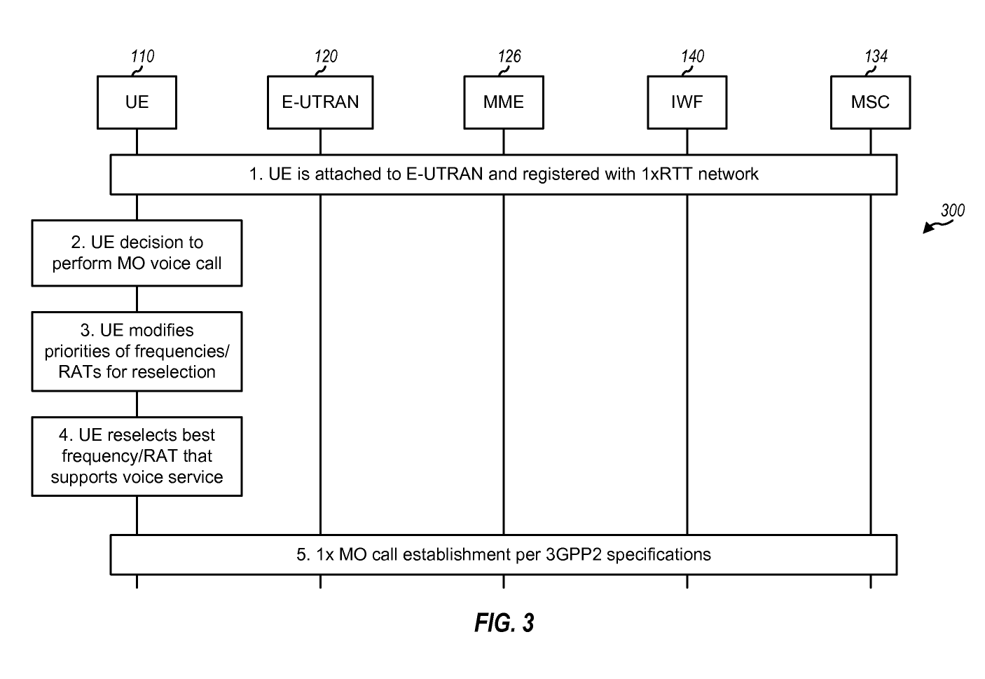

FIG. 3 shows a design of a call flow 300 for call origination with reselection to avoid CS fallback for a mobile-originated voice call. For clarity, FIG. 300 shows a case in which UE 110 is within the coverage of LTE network 102 and 1xRTT network 104. In general, call flow 300 may be used for wireless networks of any RATs.

UE 110 may be attached to E-UTRAN 120 in LTE network 102, may operate in the idle mode, and may camp on a cell of eNB 122 (step 1). UE 110 may also be registered with 1xRTT network 104 (also step 1). UE 110 may be under the coverage of both LTE network 102 and 1xRTT network 104 and may camp on LTE network 102 due to the LTE frequency having higher priority than that of the 1 xRTT frequency.

At some point in time, UE 110 may receive an indication to originate a voice call (step 2). UE 110 may then modify the priorities of the frequencies/RATs in its priority list in order to favor reselection of a RAT that can support voice service (step 3). For example, the priority list may initially include LTE frequency X having the highest priority, 1 xRTT frequency Y having the lowest priority, and 1 xRTT frequency Z having medium priority, as shown in Table 1. For reselection to avoid CS fallback, UE 110 may elevate the priority of 1 xRTT frequency Z to the highest priority, elevate the priority of 1 xRTT frequency Y to medium priority, and lower the priority of LTE frequency X to the lowest priority, as shown in Table 1. UE 110 may also modify the priorities of frequencies/RATs in other manners in order to favor reselection of a RAT supporting voice service.

TABLE 1
Reprioritization of Frequencies/RATs for Reselection
to Avoid CS Fallback

| | | Original Priority | Modified Priority |
|---|---|---|---|
| Frequency | RAT | for Reselection | to Avoid CS Fallback |
| X | LTE | Highest | Lowest |
| Y | 1xRTT | Lowest | Medium |
| Z | 1xRTT | Medium | Highest |

UE 110 may then perform reselection with the modified priority list and may reselect the best 1xRTT frequency on which a voice call can be originated (step 4). The reselection in step 4 may be performed in the normal manner based on a reselection procedure. This reselection procedure may entail (i) obtaining measurements for cells on different frequencies/RATs, (ii) identifying suitable cells, and (iii) selecting a suitable cell on the highest priority frequency/RAT. This reselection procedure may reselect an LTE frequency if the original priority list is used but may reselect a 1xRTT frequency if the modified priority list is used. After completing reselection, UE 110 may perform mobile-originated call establishment with 1xRTT network 104 in accordance with 3GPP2 specifications (step 5).

In the design shown in FIG. 3, CS fallback may be avoided without requiring any interaction between UE 110 and LTE network 102. From the perspective of LTE network 102, UE 110 is simply performing an inter-RAT cell reselection (while in the idle mode) before originating a voice call with the new RAT. In effect, UE 110 (rather than LTE network 102) can make the decision to perform CS fallback for the mobile-originated voice call. Reselection may be performed in response to an indication to originate a voice call, as shown in FIG. 3. Reselection may also be performed based on criteria other than receiving an indication to originate a voice call. Reselection may also be performed prior to receiving an indication to originate a voice call. For example, UE 110 may have limited service and may only be able to originate a voice call. In this case, UE 110 may pre-emptively ignore the priorities and camp on a RAT that supports voice service.

UE 110 may modify the priorities of frequencies/RATs in its priority list in order to enable reselection of a new RAT that supports voice service. UE 110 may be permitted to change its normal idle mode behavior and may be allowed to reorder the priorities of frequencies/RATs by itself for reselection to avoid CS fallback.

In one design, after reselecting to a target RAT as described above, UE 110 may continue to operate with the modified priority list for a time interval during which it may be undesirable for UE 110 to return to the original source RAT. This time interval may encompass the time period between camping on the target RAT and originating the voice call. Furthermore, if origination of the voice call is not immediately successful, then it may be desirable for UE 110 to remain camped on the target RAT to re-attempt the call. In such a case, UE 110 may retain the modified priorities for a longer time interval, e.g., until call origination is successful or until a certain number of failures occur. Furthermore, to support a “callback” requirement for emergency calls, in which the serving network may originate a mobile-terminated call towards a UE that previously originated an emergency call, it may be desirable for UE 110 to remain camped on the same RAT where it originated a previous emergency call. In general, the time interval during which the modified priority list is retained and used by UE 110 may be based on a time period defined in a specification, a time period signaled by the source or target network, or a time period selected by the UE itself. In any case, the time period may be sufficiently long in order to avoid ping-pong between the source and target RATs and/or to achieve the goals described above.

The modification of priorities of frequencies/RATs for reselection to avoid CS fallback may be performed in various manners. In one design, UE 110 may autonomously modify the priorities of frequencies/RATs, e.g., based on its knowledge of which RAT(s) can support voice service and/or other information stored in UE 110. The stored information may indicate which RATs are supported by UE 110, etc. In another design, UE 110 may modify the priorities of frequencies/RATs based on configuration information from a wireless network. For example, UE 110 may attach to LTE network 102, and the LTE network may become aware of the UE's support for voice service on a particular RAT, e.g., 1xRTT. LTE network 102 may then provide, as part of the idle mode configuration, an indication that UE 110 can reprioritize this particular RAT for mobile-originated voice calls.

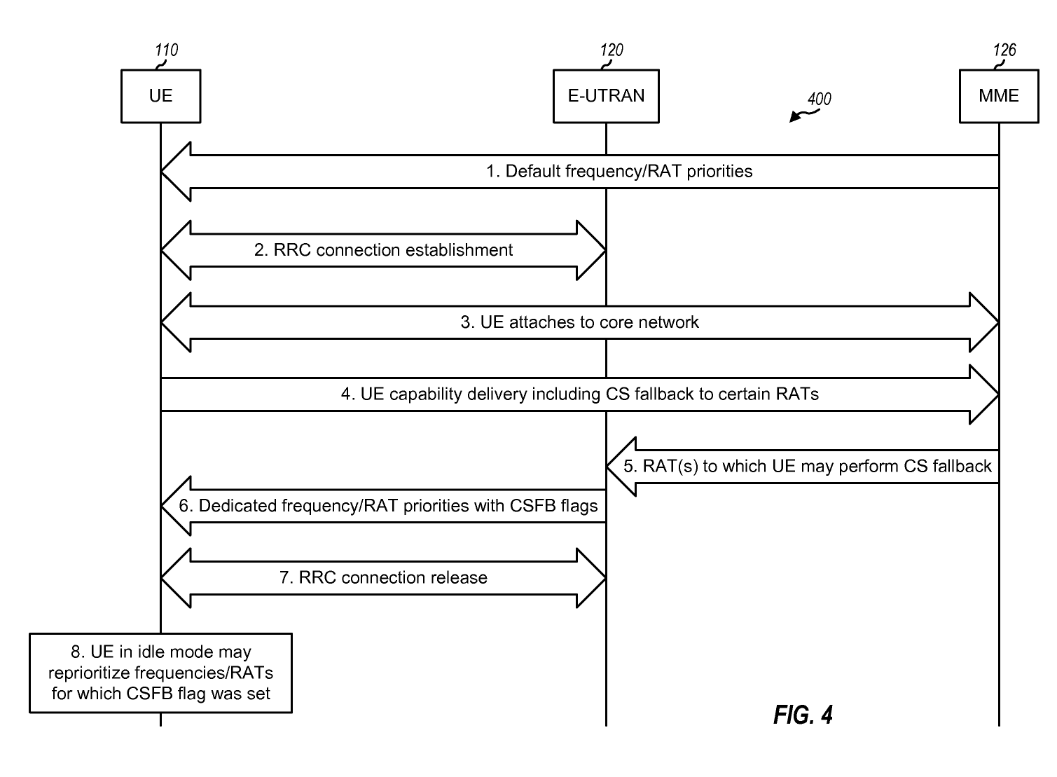

FIG. 4 shows a design of a call flow 400 for providing configuration information to control reprioritization by UE 110 for reselection to avoid CS fallback. UE 110 may initially receive a priority list of frequencies/RATs and their priorities, which may be used by UE 110 for reselection (step 1). UE 110 may receive the priority list from the current serving network (e.g., from MME 126 via E-UTRAN 120, as shown in FIG. 4), from a prior serving network, etc. The priority list may be sent to UE 110 when a connection is released, when UE 110 enters the idle mode, etc.

UE 110 may thereafter communicate with E-UTRAN 120 in LTE network 102 to establish an RRC connection (step 2). UE 110 may also communicate with MME 126 to attach to a core network (step 3). UE 110 may provide its capabilities to MME 126 (step 4). The UE capabilities may include a list of RATs supported by UE 110 for voice service, and that CS fallback to these RATs is supported by UE 110.

MME 126 may receive the UE capabilities and may determine specific RATs (if any) to which UE 110 may perform CS fallback, which may be referred to as allowed RATs. The allowed RATs may include all supported RATs, a subset of the supported RATs, or no RATs. The allowed RATs may be determined by MME 126 based on policies of a network operator. MME 126 may send the allowed RATs to E-UTRAN 120 (step 5). E-UTRAN 120 may then determine and send configuration information to UE 110 (step 6). In one design, the configuration information may include the set of frequencies in the priority list as well as a CS fallback (CSFB) flag for each frequency to indicate whether the priority of that frequency can be modified by UE 110 for reselection to avoid CS fallback. The configuration information may also include other information such as the RAT associated with each frequency, the original priority of each frequency, the modified priority of each frequency for which the CSFB flag is set, etc. The configuration information may also include other information or parameters used to reprioritize frequencies/RATs for reselection to avoid CS fallback. In any case, UE 110 may store the configuration information for possible use later. UE 110 may then communicate with E-UTRAN 120 to release the RRC connection (step 7).

A procedure to provide configuration information to UE 110 may include steps 2 through 7. At the end of this procedure, UE 110 may operate in the idle mode and may perform reselection, as appropriate, based on its priority list (step 8). However, UE 110 may reprioritize frequencies/RATs for which the CSFB flags are set when performing reselection to avoid CS fallback. The CSFB flags associated with certain frequencies/RATs may allow UE 110 to autonomously modify the priorities of these frequencies/RATs in step 3 in FIG. 3 for reselection prior to originating a mobile-originated voice call.

FIG. 4 shows an exemplary design of a message flow for providing configuration information to UE 110. Configuration information may also be provided in other manners. In general, the configuration information may convey which frequencies/RATs can have their priorities modified for reselection to avoid CS fallback. The configuration information may comprise CSFB flags or some other type of information or parameters. The configuration information may be sent specifically to UE 110 via a unicast message (as shown in FIG. 4) or may be sent via a broadcast message. In any case, the configuration information may enable network control of reselection by UE 110 to avoid CS fallback. UE 110 may make its decision based on the configuration information supplied by the network.

In another design, UE 110 may exploit its knowledge of whether a serving network supports CS fallback to a target RAT. This knowledge may be needed for other reasons and may be available to UE 110. If the serving network supports CS fallback, then UE 110 may rely on a network-controlled mechanism to obtain voice service (e.g., a more streamlined version of the call flow shown in FIG. 2). If the serving network does not support CS fallback to the target RAT, then UE 110 may perform call origination with reselection to avoid CS fallback (e.g., as shown in FIG. 3) for mobile-originated voice calls. Call origination with reselection to avoid CS fallback may thus be used as necessary.

To perform reselection, UE 110 may need to obtain signal strength measurements for cells in order to identify suitable cells. UE 110 may take a relatively long time to make the cell measurements. While in the idle mode, UE 110 may periodically make cell measurements for other frequencies and RATs at a particular minimum rate (which may be defined by the LTE standards) in order to reduce power consumption. In cases where cell measurements at the minimum rate are not required by a standard, e.g., due to a sufficiently high-quality signal from the cell on which UE 110 is currently camped, UE 110 may make cell measurements for other frequencies and RATs autonomously even though UE 110 is not required to.

In one design, to reduce delay for reselection to avoid CS fallback, UE 110 may make measurements for cells in RATs supporting voice service more frequently than the specified minimum rate. UE 110 may then have cell measurements ready for use if and when a user initiates a voice call. For example, if cell measurements are available, then UE 110 can quickly go from step 3 to step 4 in FIG. 3. In one design, if cell measurements are not available (e.g., because the cell measurements are too old or stale), then UE 110 may perform cell measurements in RATs supporting voice service and may then perform reselection. In another design, if cell measurements are not available, then UE 110 may perform call origination with CS fallback, e.g., as shown in FIG. 2. The serving network may then direct UE 110 to a target RAT supporting voice service, e.g., in step 6 in FIG. 2.

Reselection to avoid CS fallback may be used for mobile-originated voice calls, as described above. Reselection to avoid CS fallback may also be used for emergency calls, which are calls for emergency services such as police, fire, medical, etc. An emergency call may be initiated by a user dialing a well-known emergency number such as ‘911 ’ in North America or ‘112 ’ in Europe. Whenever an emergency call is detected, UE 110 may perform reselection to a target RAT in order to avoid CS fallback, e.g., using call flow 300 in FIG. 3.

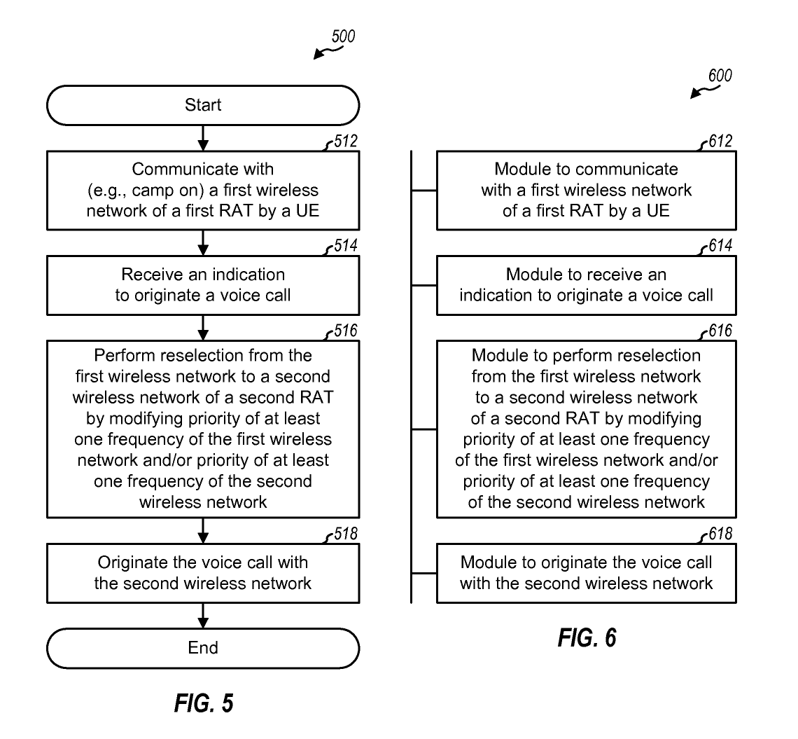

FIG. 5 shows a design of a process 500 for originating a voice call. Process 500 may be performed by a UE (as described below) or by some other entity. The UE may communicate with a first wireless network of a first RAT (block 512). For example, the UE may camp on the first wireless network while operating in an idle mode. The UE may receive an indication to originate a voice call, e.g., a regular voice call or an emergency call (block 514). The UE may then perform reselection from the first wireless network to a second wireless network of a second RAT by modifying the priority of at least one frequency of the first wireless network and/or the priority of at least one frequency of the second wireless network (block 516). The UE may then originate the voice call with the second wireless network (block 518). The first wireless network may not support voice service for the UE. The UE may originate the voice call with the second wireless network, instead of the first wireless network, in order to avoid CS fallback from the first wireless network to the second wireless network.

In one design of block 516, the UE may perform reselection based on a priority list comprising a set of frequencies, a RAT for each frequency, and a priority of each frequency. The at least one frequency of the first wireless network and the at least one frequency of the second wireless network may be included in the priority list. The UE may modify at least one priority of at least one frequency in the priority list to invoke selection of the second wireless network over the first wireless network. For example, the UE may elevate the priority of each frequency used for the second RAT and/or lower the priority of each frequency used for the first RAT to invoke selection of the second RAT over the first RAT. The UE may operate with the modified priority list for a particular time interval, which may be defined in a specification, or signaled by the first or second wireless network, or selected by the UE.

In one design, the UE may obtain a set of flags for the set of frequencies in the priority list, e.g., one flag for each frequency. The flag for each frequency may indicate whether the priority of that frequency can be modified by the UE for reselection prior to voice call origination. The UE may modify the priority of each frequency having priority that can be modified to favor selection of the second RAT over the first RAT. In one design, the UE may send capability information indicative of at least one RAT supported by the UE for voice service, e.g., to the first wireless network. The set of flags may be determined based on the at least one RAT supported by the UE for voice service. The UE may receive the set of flags from the first wireless network.

In general, the UE may receive configuration information from the first wireless network or some other wireless network. The UE may modify the priorities of the frequencies of the first wireless network and/or the second wireless network based on the configuration information. The UE may also autonomously modify the priorities of the frequencies of the wireless networks or RATs on its own, without receiving any configuration information from any wireless network.

In one design, the UE may determine whether to perform (i) call origination with CS fallback or (ii) reselection prior to call origination. In one design, the UE may determine whether CS fallback is supported by the first wireless network on which the UE is currently attached. The UE may originate the voice call with the first wireless network if CS fallback is supported by the first wireless network. The UE may perform reselection and then originate the voice call with the second wireless network if CS fallback is not supported by the first wireless network.

In another design, the UE may determine whether cell measurements are available at the UE when the indication to originate the voice call is received. The UE may originate the voice call with the first wireless network if cell measurements are not available at the UE. The UE may perform reselection if cell measurements are available at the UE. The UE may make cell measurements at a first rate if reselection prior to voice call origination is not supported. The UE may make cell measurements at a second rate, faster than the first rate, if reselection prior to voice call origination is supported.

FIG. 6 shows a design of an apparatus 600 for originating a voice call. Apparatus 600 includes a module 612 to communicate with a first wireless network of a first RAT by a UE, a module 614 to receive an indication to originate a voice call by the UE, a module 616 to perform reselection from the first wireless network to a second wireless network of a second RAT by modifying the priority of at least one frequency of the first wireless network and/or the priority of at least one frequency of the second wireless network, and a module 618 to originate the voice call with the second wireless network by the UE.

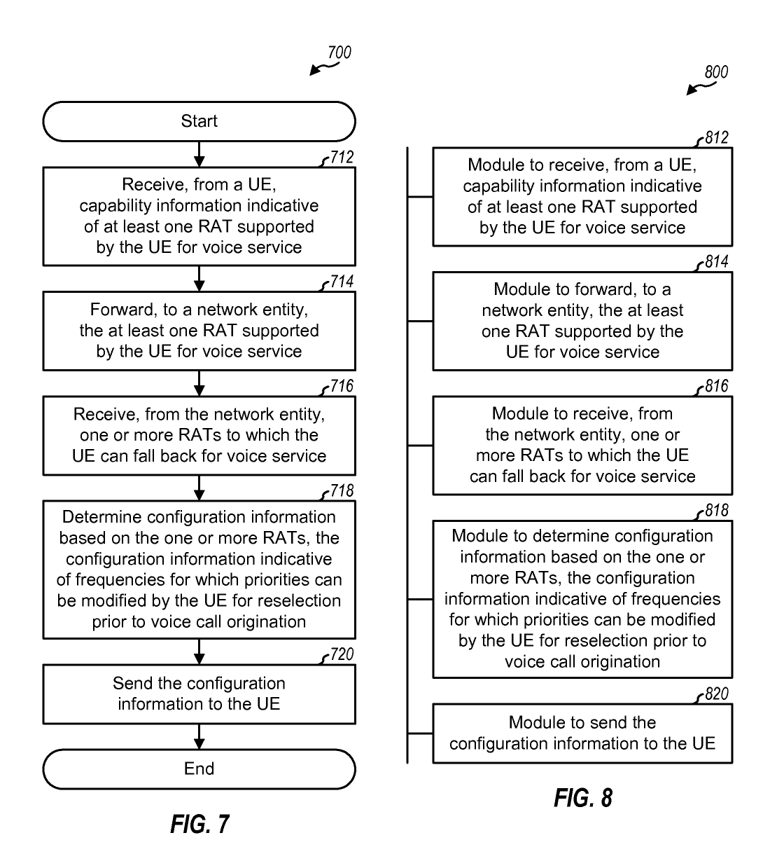

FIG. 7 shows a design of a process 700 for sending configuration information. Process 700 may be performed by a first network entity, e.g., an eNB. The first network entity may receive, from a UE, capability information indicative of at least one RAT supported by the UE for voice service (block 712). The first network entity may forward the at least one RAT supported by the UE for voice service to a second network entity (block 714). The first network entity may then receive, from the second network entity, one or more RATs to which the UE can fall back for voice service (block 716). The first network entity may determine configuration information based on the one or more RATs (block 718). The configuration information may indicate frequencies for which priorities can be modified by the UE for reselection prior to voice call origination. In one design, the configuration information may comprise a set of flags for a set of frequencies in a priority list, e.g., one flag for each frequency. The flag for each frequency may indicate whether the priority of that frequency can be modified by the UE for reselection prior to voice call origination. The configuration information may also comprise other information used for modifying priorities. In any case, the first network entity may send the configuration information to the UE (block 720).

FIG. 8 shows a design of an apparatus 800 for sending configuration information. Apparatus 800 includes a module 812 to receive, from a UE, capability information indicative of at least one RAT supported by the UE for voice service, a module 814 to forward, to a network entity, the at least one RAT supported by the UE for voice service, a module 816 to receive, from the network entity, one or more RATs to which the UE can fall back for voice service, a module 818 to determine configuration information based on the one or more RATs, and a module 820 to send the configuration information to the UE.

The modules in FIGS. 6 and 8 may comprise processors, electronics devices, hardware devices, electronics components, logical circuits, memories, software codes, firmware codes, etc., or any combination thereof.

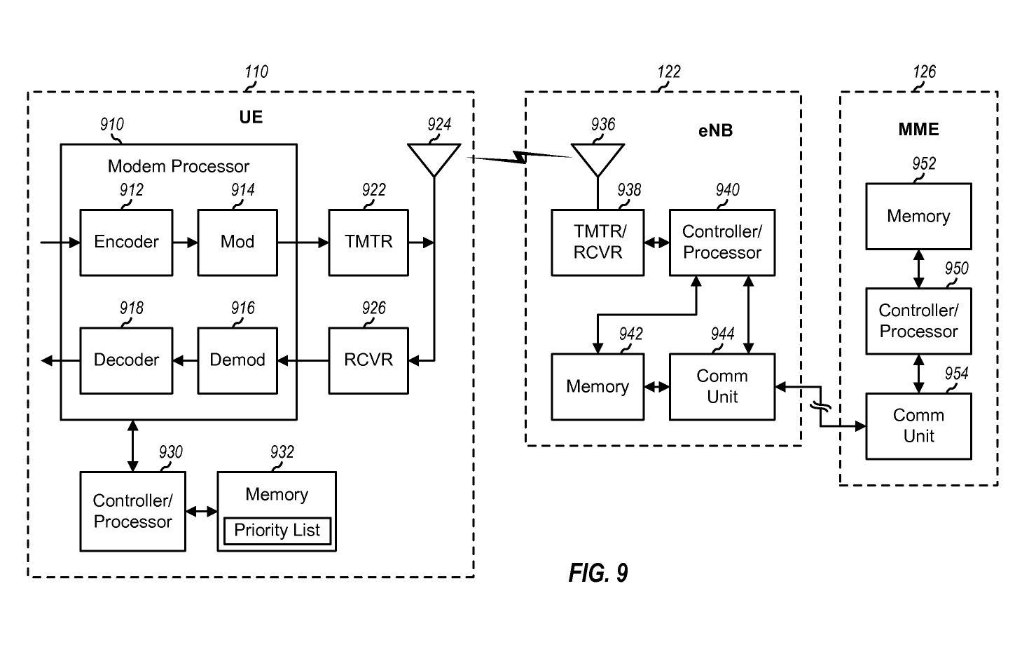

FIG. 9 shows a block diagram of a design of UE 110, eNB 122, and MME 126 in FIG. 1. At UE 110, an encoder 912 may receive traffic data and signaling messages to be sent on the uplink. Encoder 912 may process (e.g., format, encode, and interleave) the traffic data and signaling messages. A modulator (Mod) 914 may further process (e.g., symbol map and modulate) the encoded traffic data and signaling messages and provide output samples. A transmitter (TMTR) 922 may condition (e.g., convert to analog, filter, amplify, and frequency upconvert) the output samples and generate an uplink signal, which may be transmitted via an antenna 924 to eNB 122.

On the downlink, antenna 924 may receive downlink signals transmitted by eNB 122 and/or other eNBs/base stations. A receiver (RCVR) 926 may condition (e.g., filter, amplify, frequency downconvert, and digitize) the received signal from antenna 924 and provide input samples. A demodulator (Demod) 916 may process (e.g., demodulate) the input samples and provide symbol estimates. A decoder 918 may process (e.g., deinterleave and decode) the symbol estimates and provide decoded data and signaling messages sent to UE 110. Encoder 912, modulator 914, demodulator 916, and decoder 918 may be implemented by a modem processor 910. These units may perform processing in accordance with the RAT (e.g., LTE, 1xRTT, etc.) used by the wireless network with which UE 110 is in communication.

A controller/processor 930 may direct the operation at UE 110. Controller/processor 930 may also perform or direct process 500 in FIG. 5 and/or other processes for the techniques described herein. Controller/processor 930 may also perform or direct the processing by UE 110 in FIGS. 2, 3 and 4. Memory 932 may store program codes and data for UE 110. Memory 932 may also store a priority list, configuration information (e.g., CSFB flags), and/or other information that may be used to perform reselection prior to voice call origination.

At eNB 122, a transmitter/receiver 938 may support radio communication with UE 110 and other UEs. A controller/processor 940 may perform various functions for communication with the UEs. On the uplink, the uplink signal from UE 110 may be received via an antenna 936, conditioned by receiver 938, and further processed by controller/processor 940 to recover the traffic data and signaling messages sent by UE 110. On the downlink, traffic data and signaling messages may be processed by controller/processor 940 and conditioned by transmitter 938 to generate a downlink signal, which may be transmitted via antenna 936 to UE 110 and other UEs. Controller/processor 940 may also perform or direct process 700 in FIG. 7 and/or other processes for the techniques described herein. Controller/processor 940 may also perform or direct the processing by eNB 122 in FIGS. 2, 3 and 4. Memory 942 may store program codes and data for the base station. A communication (Comm) unit 944 may support communication with MME 126 and/or other network entities.

At MME 126, a controller/processor 950 may perform various functions to support communication services for UEs. Controller/processor 950 may also perform or direct the processing by MME 126 in FIGS. 2, 3 and 4. Memory 952 may store program codes and data for MME 126. A communication unit 954 may support communication with other network entities.

FIG. 9 shows simplified designs of UE 110, eNB 122, and MME 126. In general, each entity may include any number of transmitters, receivers, processors, controllers, memories, communication units, etc. Other network entities may also be implemented in similar manner.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
communicating with a first wireless network of a first radio access technology (RAT) by a user equipment (UE);
receiving an indication to originate a voice call;
performing reselection from the first wireless network to a second wireless network of a second RAT by modifying priority of at least one frequency of the first wireless network, or priority of at least one frequency of the second wireless network, or both; and
originating the voice call with the second wireless network.

2. The method of claim 1, wherein the communicating with the first wireless network comprises camping on the first wireless network while the UE is in an idle mode.

3. The method of claim 1, wherein the first wireless network does not support voice service for the UE, and wherein the voice call is originated with the second wireless network, instead of the first wireless network, to avoid circuit-switched (CS) fallback from the first wireless network to the second wireless network.

4. The method of claim 1, wherein the performing reselection comprises performing reselection based on a priority list comprising a set of frequencies, a RAT for each frequency, and a priority of each frequency, and wherein the at least one frequency of the first wireless network and the at least one frequency of the second wireless network are included in the priority list.

5. The method of claim 4, wherein the performing reselection further comprises modifying at least one priority of at least one frequency in the priority list to invoke selection of the second wireless network over the first wireless network.

6. The method of claim 5, wherein the modifying at least one priority of at least one frequency comprises elevating priority of each frequency used for the second RAT, or lowering priority of each frequency used for the first RAT, or both, to invoke selection of the second RAT over the first RAT.

7. The method of claim 5, further comprising:
operating with the at least one modified priority of the at least one frequency in the priority list for a particular time interval.

8. The method of claim 7, wherein the particular time interval is defined in a specification, or signaled by the first or second wireless network, or selected by the UE.

9. The method of claim 4, further comprising:
obtaining a set of flags for the set of frequencies in the priority list, one flag for each frequency, wherein the flag for each frequency indicates whether the priority of the frequency can be modified by the UE for reselection prior to voice call origination; and
modifying the priority of each frequency having priority that can be modified, as indicated by the flag for the frequency, to favor selection of the second RAT over the first RAT.

10. The method of claim 9, wherein the obtaining the set of flags comprises
sending, to the first wireless network, capability information indicative of at least one RAT supported by the UE for voice service, and
receiving, from the first wireless network, the set of flags determined based on the at least one RAT supported by the UE for voice service.

11. The method of claim 1, further comprising:
receiving configuration information from the first wireless network; and
modifying the priority of the at least one frequency of the first wireless network, or the priority of the at least one frequency of the second wireless network, or both based on the configuration information.

12. The method of claim 1, further comprising:
determining whether circuit-switched (CS) fallback is supported by the first wireless network;
originating the voice call with the first wireless network if CS fallback is supported by the first wireless network; and
performing reselection and originating the voice call with the second wireless network if CS fallback is not supported by the first wireless network.

13. The method of claim 1, further comprising:
determining whether cell measurements are available at the UE when the indication to originate the voice call is received;
originating the voice call with the first wireless network if cell measurements are not available at the UE; and
performing reselection if cell measurements are available at the UE.

14. The method of claim 1, further comprising:
making cell measurements at a first rate if reselection prior to voice call origination is not supported; and
making cell measurements at a second rate, faster than the first rate, if reselection prior to voice call origination is supported.

15. The method of claim 1, wherein the voice call comprises an emergency call.

16. An apparatus for wireless communication, comprising:
means for communicating with a first wireless network of a first radio access technology (RAT) by a user equipment (UE);
means for receiving an indication to originate a voice call;
means for performing reselection from the first wireless network to a second wireless network of a second RAT by modifying priority of at least one frequency of the first wireless network, or priority of at least one frequency of the second wireless network, or both; and
means for originating the voice call with the second wireless network.

17. The apparatus of claim 16, wherein the means for communicating with the first wireless network comprises means for camping on the first wireless network while the UE is in an idle mode.

18. The apparatus of claim 16, wherein the means for performing reselection comprises means for performing reselection based on a priority list comprising a set of frequencies, a RAT for each frequency, and a priority of each frequency, and wherein the at least one frequency of the first wireless network and the at least one frequency of the second wireless network are included in the priority list.

19. The apparatus of claim 18, wherein the means for performing reselection further comprises means for modifying at least one priority of at least one frequency in the priority list to invoke selection of the second wireless network over the first wireless network.

20. The apparatus of claim 18, further comprising:
means for obtaining a set of flags for the set of frequencies in the priority list, one flag for each frequency, wherein the flag for each frequency indicates whether the priority of the frequency can be modified by the UE for reselection prior to voice call origination; and
means for modifying the priority of each frequency having priority that can be modified, as indicated by the flag for the frequency, to favor selection of the second RAT over the first RAT.

21. The apparatus of claim 16, further comprising:
means for determining whether circuit-switched (CS) fallback is supported by the first wireless network;
means for originating the voice call with the first wireless network if CS fallback is supported by the first wireless network; and
means for performing reselection and originating the voice call with the second wireless network if CS fallback is not supported by the first wireless network.

22. An apparatus for wireless communication, comprising:
at least one processor configured to communicate with a first wireless network of a first radio access technology (RAT) for a user equipment (UE), to receive an indication to originate a voice call, to perform reselection from the first wireless network to a second wireless network of a second RAT by modifying priority of at least one frequency of the first wireless network, or priority of at least one frequency of the second wireless network, or both, and to originate the voice call with the second wireless network.

23. The apparatus of claim 22, wherein the at least one processor is configured to camp on the first wireless network while the UE is in an idle mode.

24. The apparatus of claim 22, wherein the at least one processor is configured to perform reselection based on a priority list comprising a set of frequencies, a RAT for each frequency, and a priority of each frequency, and wherein the at least one frequency of the first wireless network and the at least one frequency of second wireless network are included in the priority list.

25. The apparatus of claim 24, wherein the at least one processor is configured to modify at least one priority of at least one frequency in the priority list to invoke selection of the second wireless network over the first wireless network.

26. The apparatus of claim 24, wherein the at least one processor is configured to obtain a set of flags for the set of frequencies in the priority list, one flag for each frequency, wherein the flag for each frequency indicates whether the priority of the frequency can be modified by the UE for reselection prior to voice call origination, and to modify the priority of each frequency having priority that can be modified, as indicated by the flag for the frequency, to favor selection of the second RAT over the first RAT.

27. The apparatus of claim 22, wherein the at least one processor is configured to determine whether circuit-switched (CS) fallback is supported by the first wireless network, to originate the voice call with the first wireless network if CS fallback is supported by the first wireless network, and to perform reselection and originate the voice call with the second wireless network if CS fallback is not supported by the first wireless network.

28. A computer program product, comprising:
a computer-readable medium comprising:
code for causing at least one computer to communicate with a first wireless network of a first radio access technology (RAT) by a user equipment (UE),
code for causing the at least one computer to receive an indication to originate a voice call,
code for causing the at least one computer to perform reselection from the first wireless network to a second wireless network of a second RAT by modifying priority of at least one frequency of the first wireless network, or priority of at least one frequency of the second wireless network, or both and
code for causing the at least one computer to originate the voice call with the second wireless network.

29. A method for wireless communication, comprising:
receiving, from a user equipment (UE), capability information indicative of at least one radio access technology (RAT) supported by the UE for voice service; and
sending, to the UE, configuration information indicative of frequencies for which priorities can be modified by the UE for reselection prior to voice call origination.

30. The method of claim 29, further comprising:
forwarding, to a network entity, the at least one RAT supported by the UE for voice service;
receiving, from the network entity, one or more RATs to which the UE can fall back for voice service; and
determining the configuration information based on the one or more RATs.

31. The method of claim 29, wherein the UE performs reselection based on a priority list comprising a set of frequencies, a RAT for each frequency, and a priority of each frequency, wherein the configuration information comprises a set of flags for the set of frequencies in the priority list, one flag for each frequency, and wherein the flag for each frequency indicates whether the priority of the frequency can be modified by the UE for reselection prior to voice call origination.

32. An apparatus for wireless communication, comprising:
means for receiving, from a user equipment (UE), capability information indicative of at least one radio access technology (RAT) supported by the UE for voice service; and
means for sending, to the UE, configuration information indicative of frequencies for which priorities can be modified by the UE for reselection prior to voice call origination.

33. The apparatus of claim 32, further comprising:
means for forwarding, to a network entity, the at least one RAT supported by the UE for voice service;
means for receiving, from the network entity, one or more RATs to which the UE can fall back for voice service; and
means for determining the configuration information based on the one or more RATs.

34. The apparatus of claim 32, wherein the UE performs reselection based on a priority list comprising a set of frequencies, a RAT for each frequency, and a priority of each frequency, wherein the configuration information comprises a set of flags for the set of frequencies in the priority list, one flag for each frequency, and wherein the flag for each frequency indicates whether the priority of the frequency can be modified by the UE for reselection prior to voice call origination.
